(19) United States
(12) Patent Application Publication
(10) Pub. No.: US 2015/0058051 A1
(43) Pub. Date: Feb. 26, 2015

(54) PROPERTY SHARING PLATFORM

(71) Applicant: Ilya Movshovich, San Francisco, CA (US)

(72) Inventor: Ilya Movshovich, San Francisco, CA (US)

(21) Appl. No.: 14/463,386

(22) Filed: Aug. 19, 2014

Related U.S. Application Data
(60) Provisional application No. 61/868,036, filed on Aug. 20, 2013.

(51) Int. Cl. G06Q 30/06; G06Q 30/08; G06Q 50/16; G06Q 10/02

(52) U.S. Cl. CPC G06Q 30/0613; G06Q 10/02; G06Q 30/08; G06Q 50/16
USPC 705/5; 705/26.41

(57) ABSTRACT

Embodiments of the present disclosure may provide a property sharing platform. The platform may be configured to create, based on data received from an owner, a listing for a parking space and publish the listing. Then, the platform may receive search parameters from requestors seeking to temporary share the parking space. The platform may filter a plurality of published listings based on the search parameters and display the filtered plurality of listings to requestor. When a requester selects a listing, the platform may display data associated with the selected listing. The platform may further enable the requestor to bid on the parking space. The owner of the parking space may receive the bid and choose to accept the bid. The platform may then be configured facilitate a financial transaction between the requestor, the owner, and, in some instances, a charity of the owner's choice.

### RELATED APPLICATION

Under provisions of 35 U.S.C. § 119(e), the Applicant claims the benefit of U.S. provisional application No. 61/868,036 filed on Aug. 20, 2013, which is incorporated herein by reference.

### BACKGROUND

Parking may be one of the most vexed commodities in urban American life. A nation of about 300 million citizens with 255 million registered cars has as many as 800 million parking spaces, but not enough at the right place at the right time at a fair price. A family needs a place to park their car when they're home, but that space goes empty whenever they're at work. Workers need a place to park their car when they're at the office, but those spaces are unoccupied after office hours. Yet still, for all this parking bounty, it often seems that there's rarely anywhere to park. The mix of massive excess capacity and chronic shortage may be one of the biggest, most persistent, and least examined failures of the American economy. Fixing this problem may likely require better policies, but it also needs a healthy boost from the private sector.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose. In the drawings:

FIG. 1 is a flow chart of a method for providing a property sharing platform;

FIG. 2 illustrates a first user interface (UI) for an embodiment of a property sharing platform;

FIG. 3 illustrates a second UI for an embodiment of the property sharing platform;

FIG. 4 illustrates a third UI for an embodiment of the property sharing platform;

FIG. 5 illustrates a fourth UI for an embodiment of the property sharing platform;

FIG. 6 illustrates a fifth UI for an embodiment of the property sharing platform;

FIG. 7 illustrates a sixth UI for an embodiment of the property sharing platform;

FIG. 8 illustrates a seventh UI for an embodiment of the property sharing platform;

FIG. 9 illustrates a eighth UI for an embodiment of the property sharing platform;

FIG. 10 illustrates a ninth UI for an embodiment of the property sharing platform; and

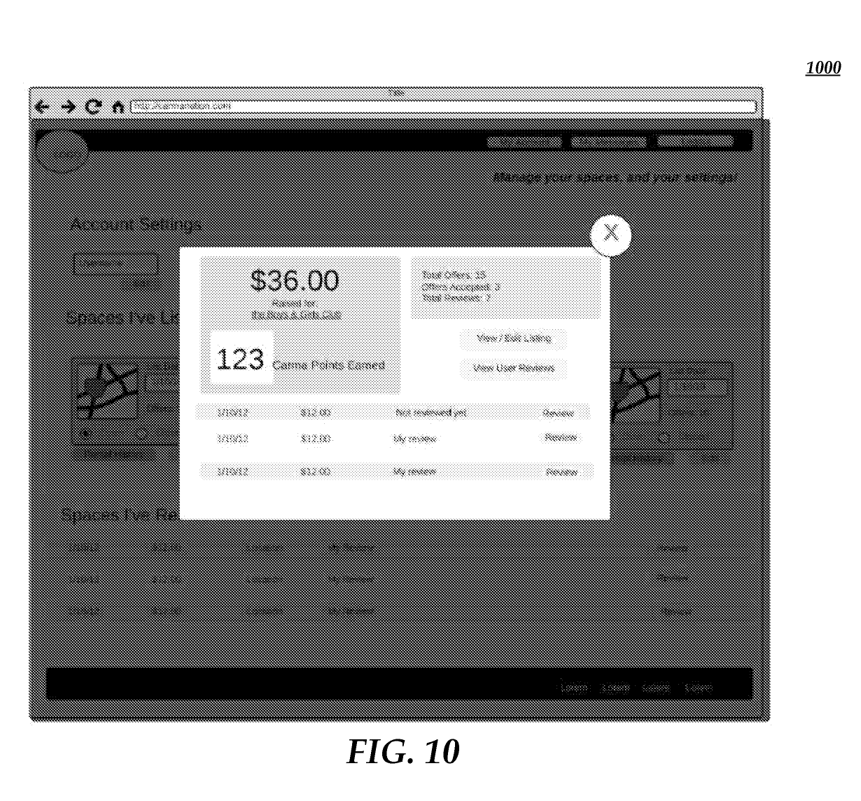

FIG. 11 is a block diagram of a computing system for providing embodiments of the property sharing platform.

### DETAILED DESCRIPTION

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers.

It should be understood that these headers are used as references and are not to be construed as limiting upon the subjected matter disclosed under the header.

### I. Platform Overview

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Consistent with embodiments of the present disclosure, a property sharing platform may be provided. The property sharing platform may enable users of the platform (e.g., individuals or organizations) to offer their property for sale, rent and/or to allow other users of the platform to temporarily use the offered property.

In addition, the property sharing platform may be used to allow users to share their property rights. For example, the users of the property sharing platform may not actually own the property they are sharing. In certain embodiments, users may only have a license to the property. For example, a user may have a permit to park in a certain area (e.g., a parking space, a parking lot, or a building). As a result, the property sharing platform may be used to allow users to share their licenses (e.g., permits, registrations, authorizations). In this way, the property shared may not necessarily be real property (e.g., real estate). Rather the property shared may be a user's rights to use real property.

In various embodiments of the present disclosure, users may offer their property in exchange for any valuable consideration. The consideration may comprise, for example, an exchange of money, services and/or goods. In some embodiments, and as will be detailed below, the platform may facilitate the donation of the consideration (i.e., money, services, or goods) to a charity.

Furthermore, the platform may employ a token system, or a points system similar to a token system. The tokens may, for example, comprise a like-monetary value and may be used as consideration for property or property rights being shared through the platform. As will be detailed below, users of the platform may purchase tokens and/or be awarded tokens for various reasons, including, but not limited to, their active use of the platform. In this way, a buyer may use tokens to, for example, rent a property offered on the platform, while the seller may receive the tokens from the buyer. These tokens may then be exchanged for monetary value or, for example, be used for other transactions within the platform. Accordingly, embodiments of the present disclosure are not limited to solely a single form of consideration in exchange for property sharing. Rather, many different types of consideration may be used.

In some embodiments, and as will be detailed below, the platform may facilitate negotiation between users. For example, the user offering the property or property rights may take offers from potential buyers and negotiate with them through an interface of the platform. In various embodiments, though not required, the offers may be bids in a bidding system. Accordingly, any standard transaction may be facilitated between the seller of the property and a buyer to secure the sharing of the property or property rights.

Moreover, it should be understood that, in many embodiments, the property shared over the platform may not actually be sold. Instead, the property may be rented for a pre-negotiated period of time. In this way, the property sharing platform may serve as a platform to license or sub-license property from one user to another. As a result, the platform may enable users to make efficient and, in certain scenarios, profitable use of their property and/or property rights.

The platform may enable, for example, the registration, listing and sharing of property for negotiated or pre-arranged durations. Using the platform, sellers of a property may create a listing for the property. The platform may then be operative to publish the listing to other users. The other users may be, for example, prospective buyers or renters of the property browsing through property listings on the platform.

The published listing may comprise information relating to the property including, but not limited to, the location of the property, a description of the property, a photo of the property, a mapped location of the property, dates and times of space availability, and a minimum cost for the property. In other embodiments, the location of the user may be manually provided by the user. In embodiments where only a property right is being offered (e.g., a parking permit) rather than the tangible property itself, the platform may be configured to list the location of the property associated with the property right. Some of the information may be provided by a user offering the property, while other information may be provided by an administrator of the platform. In various embodiments, a portion of the listed information may be retrieved by an automated back-end process performed by the platform.

Platform users who seeking available property may browse through the published listings of property on the platform. To determine the most relevant property listings to display to the user, the listings may be filtered based on a location of the user. The location of the user may be determined by, for example, input from a user device, such as, for example, a mobile computing device (e.g., a mobile phone, tablet, or laptop), a desktop computing device, or a computing device integrated into an existing system (e.g., on-board computing devices for vehicles) used to access the platform. In some embodiments, the user device may comprise components capable of gathering location information and inputting the location information to the platform. The location gathering components may comprise, but are not limited to, for example, a Global Positioning System, antenna triangulation algorithms, an IP address, or any other means from which the location of the user device may be derived. The platform may be capable of receiving and parsing this information to determine the location of the user.

Having the location of the user, the platform may then be operative to display those listings that are associated with property within a predetermined radius of the user. In various embodiments, the radius may be defined by the user and/or set by a default parameter configurable by the user. Still consistent with embodiments of the present disclosure, the property sharing platform may also enable buyers to further search the listings by dates and times of availability, and/or by cost.

In some embodiments, the property sharing platform may enable potential buyers to place bids on desired property. The user that registered and published the property may receive a notification of the bids and process the bids as necessary. Moreover, the platform may provide an interface for placing and managing the bidding system as will be described in greater detail below.

The platform may further comprise an interface for facilitating agreements on the renting, leasing, or sub-leasing of a property listed on the platform. The interface will be described in greater detail below. Furthermore, the platform may facilitate payment transactions between the buyer and seller. In other embodiments, the platform may enable the buyer and seller to arrange for payment amongst themselves. As mentioned above, the property sharing platform consistent with embodiments of the present disclosure may enable the seller to elect to donate the money from the sale of their property to a particular charity.

Though the following disclosure describes embodiments of disclosure in the context of sharing parking spaces, the disclosure is not limited to parking space sharing alone. Rather, parking space sharing is disclosed as one example of property sharing facilitated in accordance to the various embodiments of the present disclosure.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### II. Platform Operation

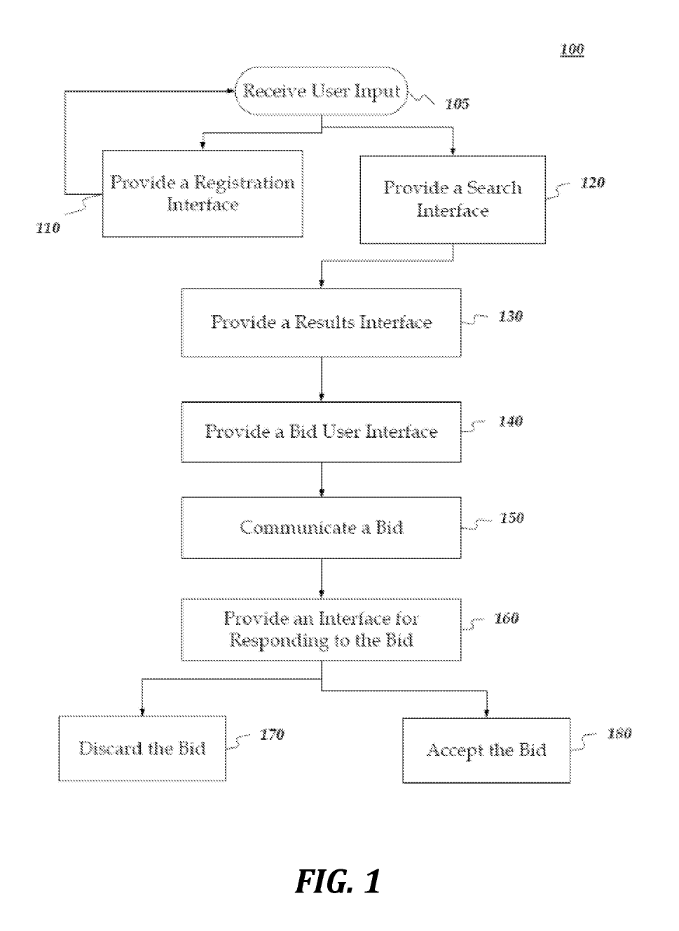

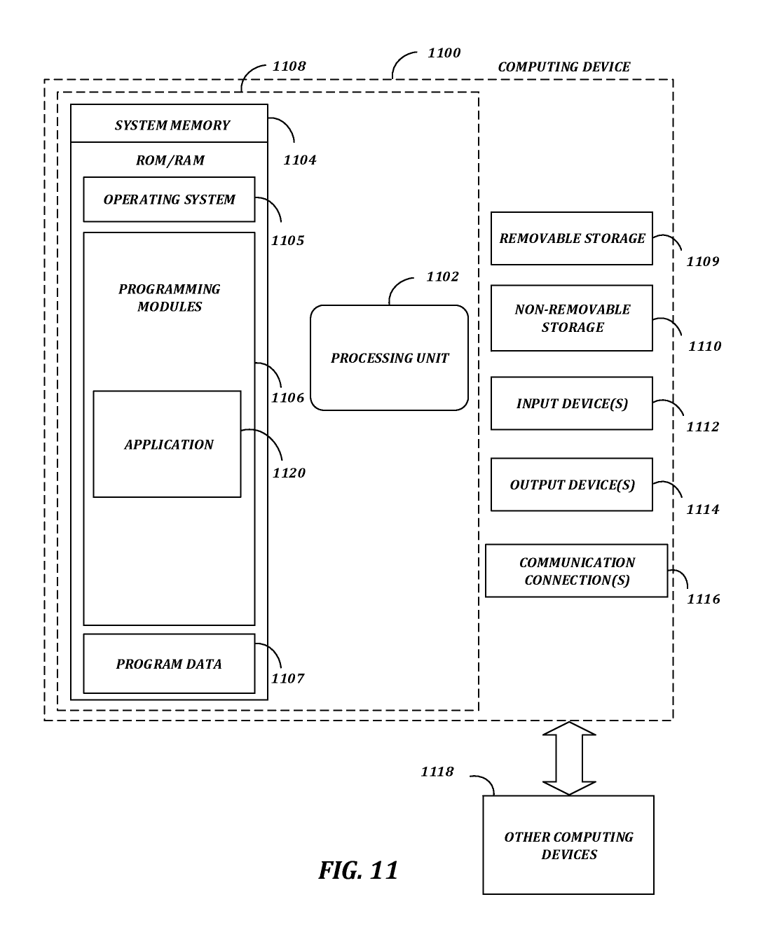

FIG. 1 is a flow chart setting forth the general stages involved in a method 100 consistent with an embodiment of the disclosure for providing a property sharing platform. Method 100 may be implemented using a computing device 1100 as described in more detail below with respect to FIG. 11. The computing device may comprise a property sharing platform application installed therein. The property sharing application, in turn, may be operative to implement at least one of the stages described by method 100.

Although method 100 has been described to be performed by a computing device 1100, it should be understood that, in some embodiments, different operations may be performed by different networked elements in operative communication with computing device 1100. For example, a server in communication with computing device 1100 may be employed in the performance of some or all of the stages in method 100. Moreover, in some embodiments, the server may be configured much like computing device 1100 as descried in FIG. 11.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 100 will be described in greater detail below.

The user may first register and login to the platform using manually inputted credentials. The user may further tie any registration and login to a social network to which the user belongs. This includes, but is not limited to, Facebook, Twitter, LinkedIn, My Space, and the like. In this way, a user profile may be created for the user consistent with an existing social network profile. Moreover, having tied the user profile to a social network, the platform may be enabled to share the user's activity on the platform to the social network.

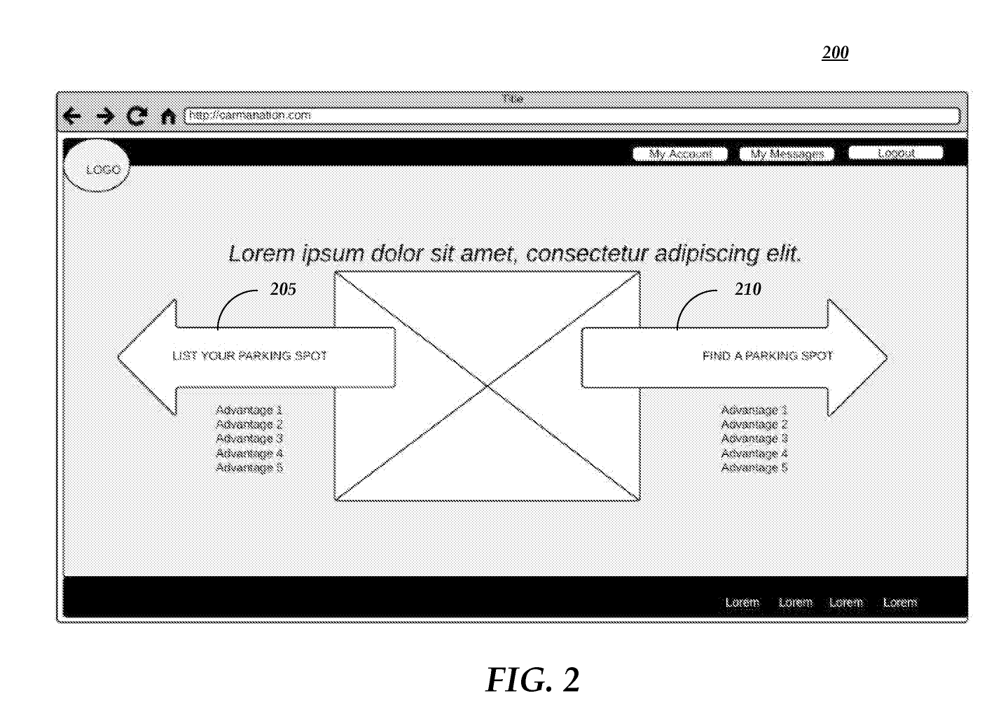

Method 100 may begin at stage 105, wherein the platform awaits a user input. The user input may specify whether the user would like to use the platform to register a parking space or to search for an available parking space. FIG. 2 illustrates an embodiment of a user interface 200 for receiving the user input. Interface 200 may provide the user with a first option 205 to list property to the platform and a second option 210 to find property through the platform.

From stage 105, method 100 may enter stage 110 when the input received corresponds to a request to register a parking space listing from a first user (e.g., a seller of first option 205). Alternatively, method 100 may enter stage 120 when the input received corresponds to a request to find a parking space from a second user (e.g., a buyer selection of second option 210).

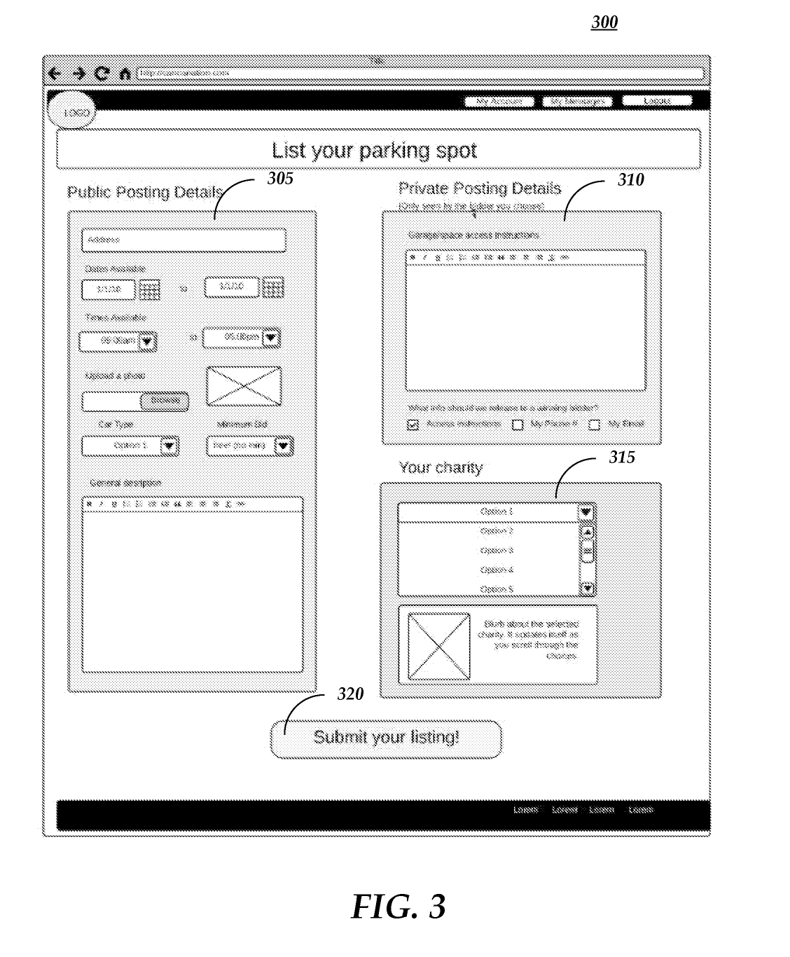

Upon entering stage 110, the property sharing platform may present the first user with a parking space listing registration user interface. One embodiment of the registration user interface 300 is illustrated in FIG. 3. Said registration user interface may be comprised of various input elements, such as text boxes, drop down menus, radio buttons, check boxes, buttons, etc. Consistent with embodiments of the disclosure, the listing creation user interface may enable the first user to input public information 305. Public information 305 may comprise, but not be limited to, for example, information relating to the parking space to be listed for sale, including but not limited to, the address of the parking space, the times and dates/days the parking space is available, a picture of the parking space, vehicle types that are acceptable to utilize the parking space, a minimum acceptable bid on the parking space, and a written description of the parking space. In various embodiments, and as mentioned above, the location data may be automatically populated into the search user interface based on location information derived from a user device associated with the first user.

Interface 300 may further comprise private information 305. Private information 305 may comprise, but not be limited to, for example, instructions to access the parking space, and the contact information of the first user. Furthermore, interface 300 may allow the first user to select a charity to receive payment for the parking space on their behalf (shown as charity information 315).

The first user may designate some of these inputs to be listed publically in the parking space listing, while other inputs may only be viewable by other users upon special designation of the first user. The listing creation user interface 300 may provide a button 320 to submit the parking space listing to the platform. After the first user elects to submit the listing, a record of the parking space listing may be created and stored in a parking space listing database, at which point method 100 may, in some embodiments, return to stage 105.

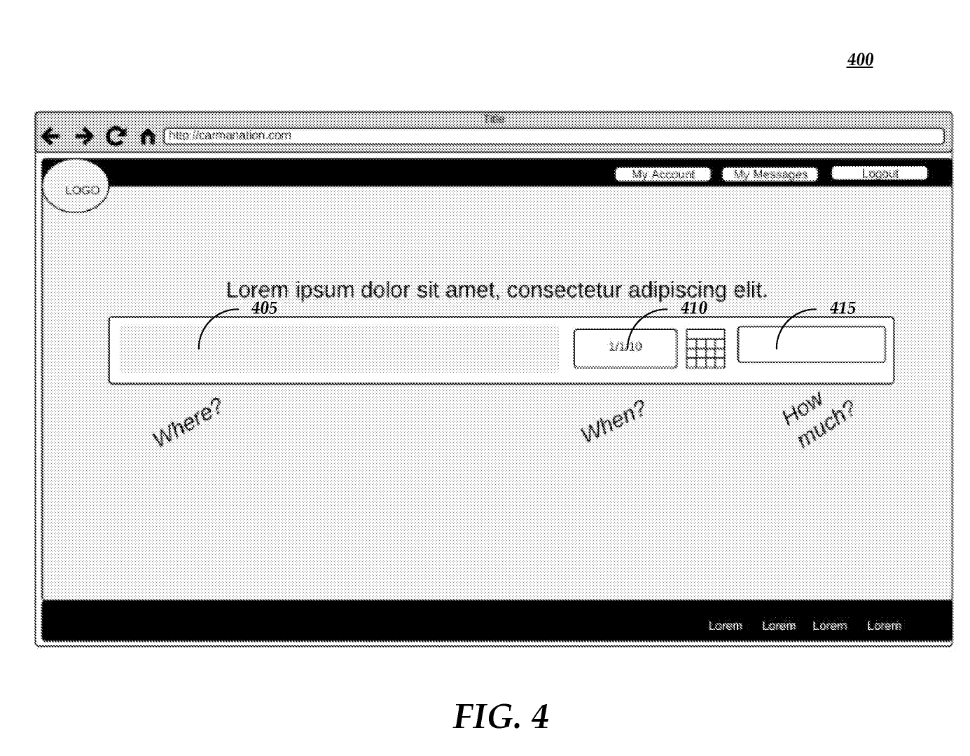

Upon entering stage 120, the property sharing platform may present the second user with a parking space listing search user interface. One embodiment of the search user interface 400 is illustrated in FIG. 4. Said parking space listing search user interface 400 may enable a second user to input parameters to search the parking space listings database. Such parameters may comprise, but are not limited to, for example, location data 405 representing the desired location of a parking space, the times and dates 410 of desired usage of a parking space, and a desired purchase price 415 of a parking space. All of these elements need not be present in search user interface. Rather, any combination of elements may be used. The location data 405 may be comprised of, but not limited to, for example, addresses, GPS coordinates, zip codes, landmarks, town names, etc. In various embodiments, and as mentioned above, the location data 405 may be automatically populated into the search user interface 400 based on location information derived from a user device associated with the second user.

Consistent with embodiments of the disclosure, the search interface 400 may provide for the selection from a calendar to enable the second user (e.g., the buyer) to select a desired date or range of dates. The desired purchase price of a parking space may be designated as a maximum price the potential buyer is willing to pay. Furthermore, the parking space listing search user interface 400 may provide for a button enabling the second user to initiate a search of the parking space listings database, based on the input of any number of the inputted search parameters.

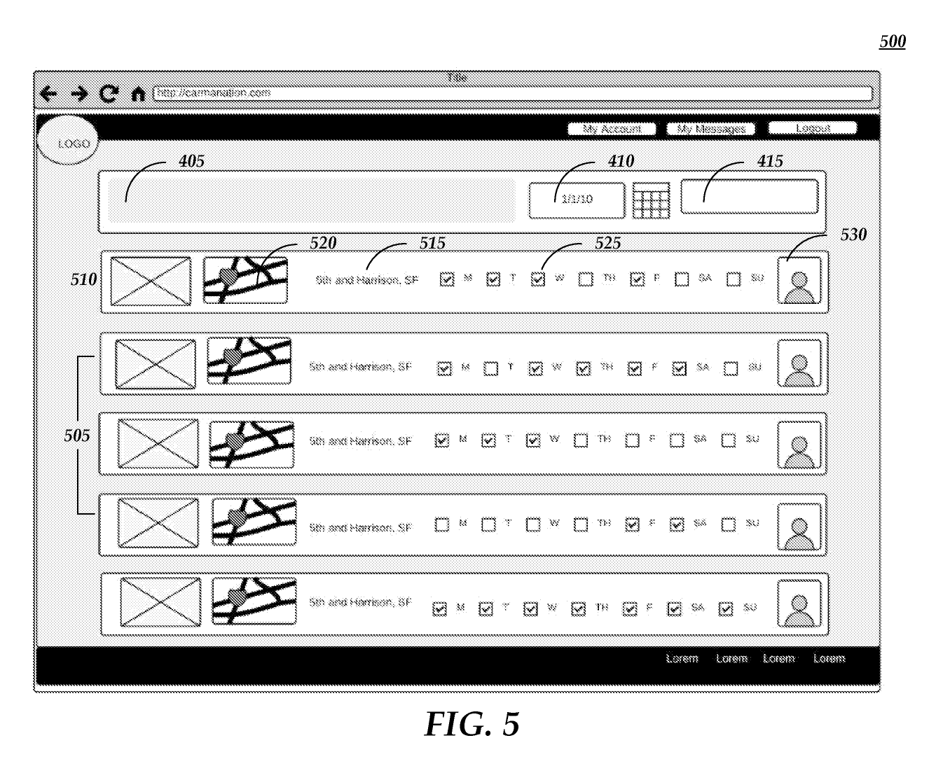

Method 100 may advance to stage 130 from stage 120 in response to the execution of a search by the second user. Upon entering stage 130, the property sharing platform may present the second user with a parking space results user interface. One embodiment of the results user interface 500 is illustrated in FIG. 5. Said parking space results user interface 500 may display results in the form of a list of parking space records 505, wherein each record may correspond to a parking space that has been listed for sale. The listed results may be based on the search parameters (e.g., location data 405, time and date 410, and price 415).

Consistent with embodiments of the present disclosure, a parking space record 510 may display information relating to the parking space listing including, but not limited to, the address of the parking space 515, a map indicating the location of the parking space 520, times and dates/days of the week in which the space is available for purchase 525, information identifying the user offering the parking space for sale 530, and ratings data associated with the seller. In various embodiments, certain listings may receive a higher ranking and/or promotion based on various factors, including, but not limited to, relevancy to the search parameters, a promotion, or the user ratings data.

The promotions and user ratings data may be based on supplemental payments for the listing and/or user reviews. The results user interface 500 may provide the second user with an option to filter or sort the results based on various factors including, but not limited to, seller, price, distance, date of availability, reviews, and/or charity listed by the seller. Each of the displayed results may be selectable via a selectable element displayed with the listing.

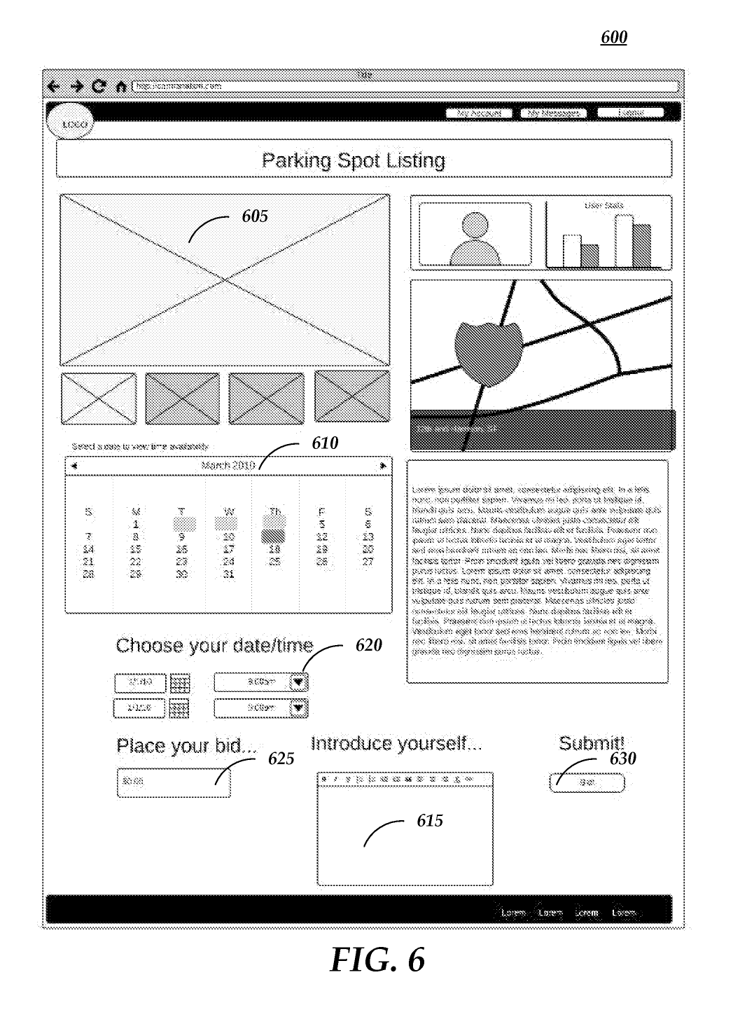

From stage 130, Method 100 may advance to stage 140 in response to the selection of a particular parking space record by the second user. Upon entering stage 140, the property sharing platform may present the second user with a bid user interface. One embodiment the bid user interface 600 consistent with embodiments of the present disclosure is illustrated in FIG. 6. The bid user interface 600 may display parking space data 605 provided by the first user during stage 110. In addition, the bid user interface 600 may comprise a date selection tool such as, for example, a calendar 610, to allow the second user to view the availability of the parking space and to select at least one date on which the second user would like to share the parking space. The bid user interface may also comprise an input field 615 in which the second user may provide information to the first user. The information may comprise, but not be limited to, for example, a brief description of the second user and/or comments, questions, or special requests the second user may have. The information inputted by the second user may, in turn, be provided to the second user for review.

The bid user interface 600 may further provide an input field for enabling the second user to place a bid on the parking space. For example, the second user may select at least one date and time 620 on which he would like to reserve the parking, along with an input field 625 for amount of money the second user is willing to bid. In various embodiments, the second user may not need to bid on the parking space. Rather, the first user (e.g., seller) may set an hourly and/or daily set price for the parking space. In turn, the user interface 600 may provide the set price upon receiving the time/date inputs from the first user (e.g., buyer). As such, the bid user interface 600 may still provide the input field for enabling the second user to place a monetary bid on the parking space, but such input field 625 may be optional, acceptable only at the seller's discretion. The bid user interface may provide a button 630 enabling the second user to submit the bid to the platform.

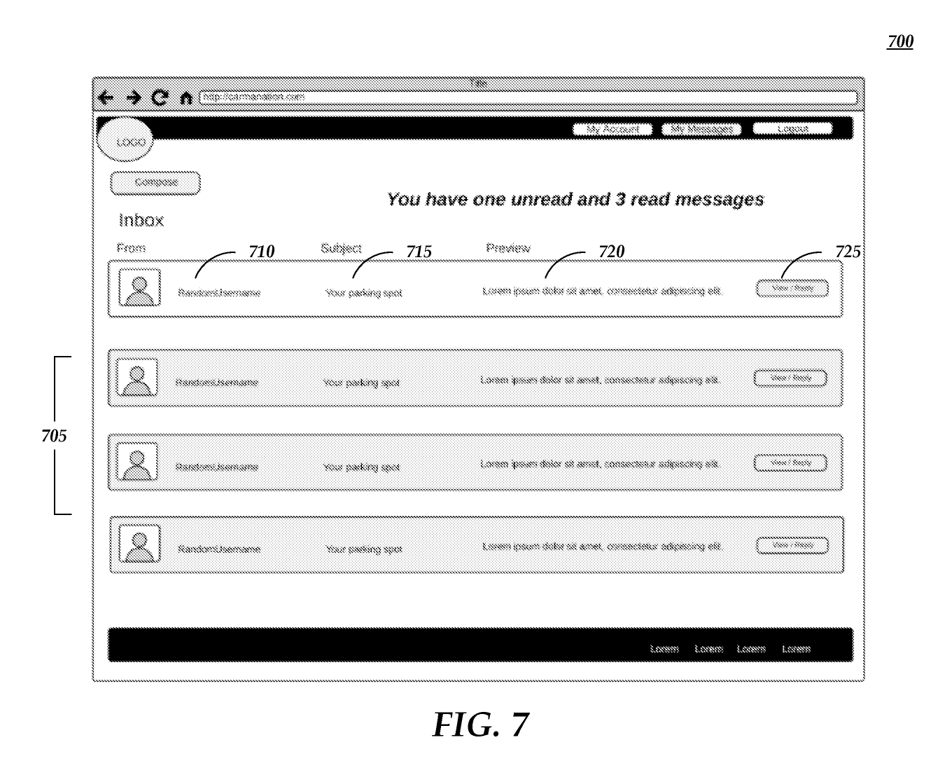

Method 100 may proceed to stage 150 from stage 140 upon the submission of, for example, a bid by the second user. In stage 150, the property sharing platform may facilitate communication of the bid from the second user to the first user. This may be accomplished through any form of electronic communication, including but not limited to, notifying the first user of the bid by telephone, text message, email, or messaging capabilities that may be provided within, or operatively associated with, the platform. For example, the platform may present the first user with an inbox user interface. One embodiment of the inbox user interface 700 is illustrated in FIG. 7.

Said inbox user interface 700 may provide, for example, a listing of 705 sent by other users. The listing of messages may provide message information such as, but not limited to, the username 710 of the sender of the message, the subject of the message 715, and a preview of the message 720. In some embodiments, a button 725 may be provided with the list of messages which, upon selection, enables the first user to select a particular message for further viewing. The messages may comprise, for example, bid information as well as any input the second user submitted along with the bid information. Though the inbox is described in the context of the first user throughout this disclosure, embodiments of the present disclosure may provide a similar inbox user interface to the second user.

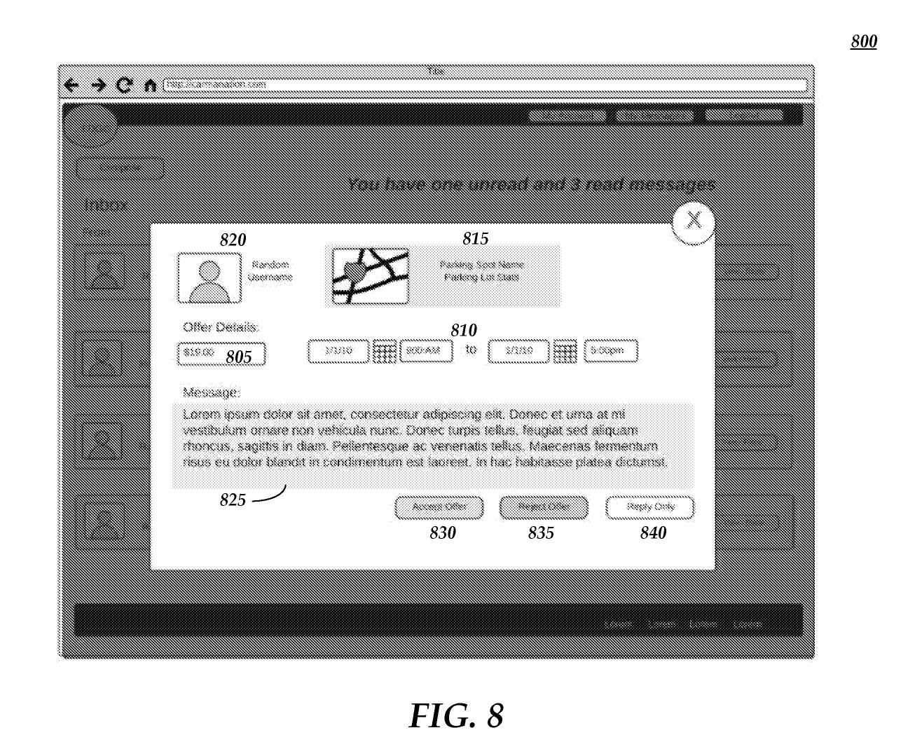

Method 100 may enter stage 160 from stage 150 in response to the selection of a message for further viewing by the first user. Upon entering stage 160, the property sharing platform may present the first user with a message user interface. One embodiment of the message user interface 800 is illustrated in FIG. 8. Said message user interface 800 may provide a representation of bid (i.e., offer) parameters submitted by the second user in the bid user interface provided in stage 140, including, but not limited to, bid amount 805, dates and times 810 of desired use of parking space, information 815 identifying the parking space that is the subject of the bid, information identifying the identity of the second user 820, and a message 825 composed by the second user in association with the bid. Said message user interface may further provide buttons allowing a first user to accept the bid offer 830, reject the bid offer 835 or reply to the bid offer 840 with a message or, for example, counter offer.

Method 100 may advance to stage 170 upon receiving a selection from the first user to reject the bid offer. Upon entering stage 170, the platform may discard the bid provided by the second user. In various other embodiments, the platform may be designed to retain the bid data provided by the second user in order to enable the second user to revise the bid. The platform may further be operative to notify the second user via, for example, the inbox user interface or any other suitable form of communication, that the bid was rejected.

Alternatively, method 100 may advance to stage 180 in response to an acceptance of the bid offer by the first user. Upon entering stage 180, the platform may notify the second user that the bid offer was accepted by the first user. The platform may then facilitate a payment from the second user to the first user using conventional payment processing technology available to one of ordinary skill in the art. In some embodiments, the platform may further be operative to facilitate transfer of the payment to a charity set by the first user. In other embodiments, the platform may be operative to allow payment to be transferred to a charity designated by the second user.

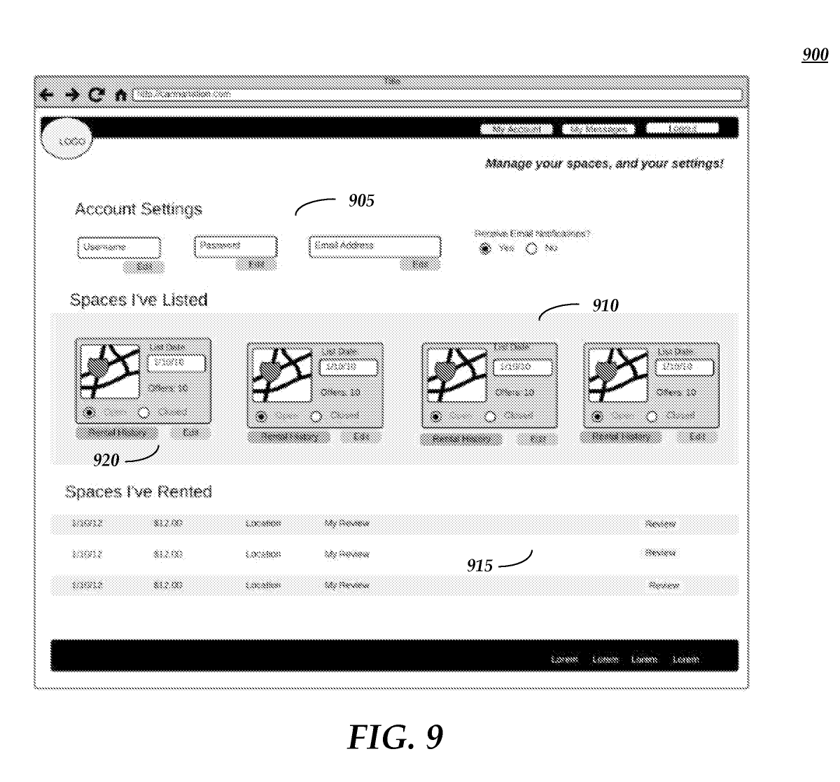

The property sharing platform may create and store a record of the parking space purchase, and display the record in an overview user interface. One embodiment of an overview/account summary user interface is illustrated in FIG. 9. Said overview user interface may provide user specific data, such as, but not limited to, username, password, contact information (group 905), records of parking spaces listed for sale by the user 910 and records of parking spaces purchased by the user 915.

Furthermore, said overview user interface may provide buttons including, but not limited to, enabling a user to edit user information, edit details of listed parking spaces, view rental history of listed parking spaces, and provide reviews of purchased parking spaces (group 920). Selection of one of these buttons may present a user with an account summary user interface. Said account summary user interface may display information related to a particular parking space, for example, data on the number of offers received and accepted on the space, reviews of the space, purchase history of the parking space, total funds raised by the space, etc.

Consistent with embodiments of the disclosure, the platform may be operative to track a location of the second user (e.g., buyer). The tracked location may be provided, via the platform, to the first user (e.g., seller) when the seller has accepted the bid of the buyer. In various embodiments, location tracking may be requested by the seller and subsequently enabled by the buyer when the buyer is within a predetermined radius of the parking space. In this way, the seller may be enabled to track the buyer and monitor the usage of the parking space.

Still consistent with embodiments of the disclosure, the buyer may be enabled to check-in, via the platform, once the buyer has occupied the seller's parking space. A check-in notification may be provided to the seller. In this way, the seller may know that the parking space is occupied. The check-in notification may be posted to a seller's and/or buyer's social network, along with a customized message from the seller and/or buyer. The social network may be a social network tied to the seller's and/or buyer's profile within the platform.

In various embodiments, the check-in may be mandatory and/or automatically submitted to the platform upon a detection that the buyer is within the premises of the seller's parking space. For example, the location tracking elements of the buyer's device may be monitored by the platform. Once the platform detects that the buyer is within the premises of the parking space, the platform may, for example, notify the seller.

Still consistent with embodiments of the present disclosure, the seller may be enabled to communicate, via the platform, access codes with the buyer. The access codes may be used to access a private parking space. In some embodiments, the access code may be communicated in the form of a communicable code (e.g., a one-time, scrambled garage door opener code) sent to the user's device. The communicable code may be used to program, for example, a garage door opener. In other embodiments, the user device receiving the code may be directly operative with the code (e.g., on-board computing device integrated into the user's vehicle).

In further embodiments of the present disclosure, the platform may initiate a timer once the buyer begins to occupy the parking space. The timer may be set to expire upon a fulfillment of the time purchased by the buyer. Upon the timer's expiration, the platform may be enabled to issue a notification to both the seller and the buyer. If the buyer is still occupying the parking space upon the timer's expiration, the platform may be enabled to track and further charge the buyer for the additional time the buyer has occupied the parking space. The charge may be based on, for example, a predetermined rate set by the seller.

In addition, the timer may be configured to stop counting when the location elements of the buyer's device have indicated that the buyer is no longer occupying the parking space. In turn, the platform may be configured to issue a notification to the seller, indicating the buyer is no longer occupying the seller's parking space.

Still consistent with embodiments of the present disclosure, a system may be provided for performing a method for collecting and managing information about available resources. The system may be further operative to perform a method for distributing those resources between qualified users on a computer social network. The system may comprise a memory storage and a processing unit coupled to the memory storage. Accordingly, FIG. 11 may, in some embodiments, describe the system as computing device 1100.

The processing unit may be configured to execute a set of instructions stored on the memory storage. The set of instructions may comprise, for example, the property sharing platform and/or application thereof. In this way, the processing unit may be configured to, for example, store a plurality of data provided by registered legitimate owners of resources to a central database. Various checks may be performed to determine the legitimacy of property (e.g., a resource) ownership, although they are not necessary in some embodiments. The data stored may include, but not be limited to, for example, resource properties, terms of using the resource, and any special conditions for resources availability.

The processing unit may be further configured to, for example, enable registered potential consumers of those resources to perform customized search and display information about up-to-date available resources. The processing unit may then be configured to monitor decisions of registered potential consumers to acquire at least some of the resources identified during a customized search; and request and obtain from registered potential consumers explicit agreement to comply with the terms of use by registered legitimate owners of resources.

In accordance to embodiments of the present disclosure, compliance with the requirements defined by the registered legitimate owners of resources may be verified. Upon verification, the potential consumers may be granted rights to use available resources. Moreover, embodiments of the present disclosure may arbitrate registered potential consumers' requests to guarantee non-over-allocating assignment of available resources. In turn, already allocated resources may be prohibited from being searched and displayed during subsequent searches. Finally, various embodiments may be operative to collect information about the registered consumer who was granted the right to use specific resource. The collected information may be, optionally, provided to the registered legitimate owner of the resource.

### III. Platform Architecture

The platform of the present disclosure may be embodied as, for example, but not be limited to, a website, a web application, a desktop application, and a mobile application compatible with a computing device. Moreover, the platform may be hosted on a centralized server, such as, for example, a cloud computing service. Although method 100 has been described to be performed by a computing device 1100, it should be understood that, in some embodiments, different operations may be performed by different networked elements in operative communication with computing device 1100.

FIG. 11 is a block diagram of a system including computing device 1100. Consistent with an embodiment of the disclosure, the aforementioned memory storage and processing unit may be implemented in a computing device, such as computing device 1100 of FIG. 11. Any suitable combination of hardware, software, or firmware may be used to implement the memory storage and processing unit. For example, the memory storage and processing unit may be implemented with computing device 1100 or any of other computing devices 1118, in combination with computing device 1100. The aforementioned system, device, and processors are examples and other systems, devices, and processors may comprise the aforementioned memory storage and processing unit, consistent with embodiments of the disclosure.

With reference to FIG. 11, a system consistent with an embodiment of the disclosure may include a computing device, such as computing device 1100. In a basic configuration, computing device 1100 may include at least one processing unit 1102 and a system memory 1104. Depending on the configuration and type of computing device, system memory 1104 may comprise, but is not limited to, volatile (e.g. random access memory

(RAM)), non-volatile (e.g. read-only memory (ROM)), flash memory, or any combination. System memory 1104 may include operating system 1105, one or more programming modules 1106, and may include a program data 1107. Operating system 1105, for example, may be suitable for controlling computing device 1100′s operation. In one embodiment, programming modules 1106 may include property sharing application 1120. Furthermore, embodiments of the disclosure may be practiced in conjunction with a graphics library, other operating systems, or any other application program and is not limited to any particular application or system. This basic configuration is illustrated in FIG. 11 by those components within a dashed line 1108.

Computing device 1100 may have additional features or functionality. For example, computing device 1100 may also include additional data storage devices (removable and/or non-removable) such as, for example, magnetic disks, optical disks, or tape. Such additional storage is illustrated in FIG. 11 by a removable storage 1109 and a non-removable storage 1110. Computer storage media may include volatile and nonvolatile, removable and non-removable media implemented in any method or technology for storage of information, such as computer readable instructions, data structures, program modules, or other data. System memory 1104, removable storage 1109, and non-removable storage 1110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1100. Any such computer storage media may be part of device 1100. Computing device 1100 may also have input device(s) 1112 such as a keyboard, a mouse, a pen, a sound input device, a touch input device, etc. Output device(s) 1114 such as a display, speakers, a printer, etc. may also be included. The aforementioned devices are examples and others may be used.

Computing device 1100 may also contain a communication connection 1116 that may allow device 1100 to communicate with other computing devices 1118, such as over a network in a distributed computing environment, for example, an intranet or the Internet. Communication connection 1116 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1104, including operating system 1105. While executing on processing unit 1102, programming modules 1106 (e.g., property sharing application 1120) may perform processes including, for example, one or more method 100′s stages as described above. The aforementioned process is an example, and processing unit 1102 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### IV. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A method comprising:
receiving a first set of inputs from a first user, the first set of inputs comprising information associated with at least one the following: a location of a property, a time the property is available, and a cost for occupying the property within the available time;
creating, based on the first set of inputs, a listing for the property;
publishing the listing in a first user interface, the first user interface comprising a plurality of listings;
receiving a second set of inputs from a second user, the second set of inputs comprising at least one of the following: an approximate location and a period of time;
filtering the plurality of listings based on the second set of inputs;
displaying, in the first user interface, the filtered plurality of listings to the second user;
receiving, from the second user, a selection of one the plurality of listings;
providing a second user interface to the second user, the second user interface being operative to:
display property data associated with the selected one of the plurality of listing, and
enable the second user to request use of the property;
receiving a request to use the property from the second user;
conveying the request to use the property to the first user;
receiving an acceptance of the request from the first user; and
facilitating a financial transaction between the first user and the second user.

2. The method of claim 1, wherein facilitating the financial transaction between the first user and the second user comprises facilitating the financial transaction to a charitable organization.

3. The method of claim 1, further comprising notifying the first user when the second user is occupying the property.

4. The method of claim 3, wherein notifying the first user when the second user is occupying the property comprises enabling the second user to check-in once the second user is within a premises of the property.

5. The method of claim 3, further comprising initiating a timer once the second user has occupied the property.

6. The method of claim 5, further comprising notifying at least one of: the first user and the second user that the timer has expired.

7. The method of claim 6, further comprising issuing a charge to the second user for having occupied the property for a period of time beyond the timer's expiration.

8. The method of claim 1, further comprising tracking a location of the second user.

9. The method of claim 8, further comprising notifying the first user once the tracked location of the second user is within a premises of the property.

10. The method of claim 1, wherein displaying, in the first user interface, the filtered plurality of listings to the second user comprises enabling the second user to sort the filtered plurality of listings based on at least one of the following: a price, a distance, a seller, and a charity associated with each listing.

11. A computer-readable medium having a set of instructions stored thereon which, when executed by a computer, perform a method, the method executed by the set of instructions comprising:
receiving a set of search parameters to locate an available parking space, the search parameters indicating at least one of the following: a time and a location;
providing a listing of search results;
receiving a selection of one the listings;
providing, in response to the selection, public details associated with the available parking space corresponding to the selected listing;
receiving a request to use the parking space; and
conveying private details associated with the use of the parking space.

12. The computer-readable medium of claim 11, further comprising notifying an owner of the parking space when the parking space is being occupied.

13. The computer-readable medium of claim 12, wherein notifying owner comprises enabling a user to check-in once the user is within a premises of the parking space.

14. The computer-readable medium of claim 12, further comprising initiating a timer once an indication of occupancy is received from the user.

15. The computer-readable medium of claim 14, further comprising issuing a charge to the user for having occupied the property for a period of time indicated by the timer.

16. The computer-readable medium of claim 11, further comprising tracking a location of a user requesting the parking space.

17. The computer-readable medium of claim 16, further comprising notifying an owner of the parking space once the tracked location of the user is within a premises of the parking space.

18. A system comprising:
a memory storage; and
a processing unit coupled to the memory storage, the processing unit being configured to:
create, based on the first set of inputs, a listing for a property;
publish the listing;
receive a second set of inputs, the second set of inputs comprising search parameters;
filter a plurality of published listings based on the second set of inputs;
display the filtered plurality of listings to the second user;
receive a selection of one the plurality of listings;
display property data associated with the selected one of the plurality of listing
receiving a request, from a requestor, to use the property;
convey the request to use the property to a listing owner;
receive an acceptance of the request from the owner; and
facilitate a financial transaction between the requestor and the owner.

19. The computer-readable medium of claim 18, further comprising notifying the owner of the property when the property is being occupied.

20. The computer-readable medium of claim 19, wherein notifying owner comprises enabling a user to check-in once the requestor is within a premises of the property.
